(19) United States
(12) Patent Application Publication
(10) Pub. No.: US 2023/0111146 A1
(43) Pub. Date: Apr. 13, 2023

(54) SYSTEMS AND METHODS FOR INTEGRATING KNOWLEDGE FROM A PLURALITY OF DATA SOURCES

(71) Applicant: Script String Limited, Burlington (CA)

(72) Inventors: Warren Andrew Gedge, Burlington (CA); Sheldon Warren Sawchuk, Scarborough (CA); Bruce Sebastian Affonso, Mississauga (CA); Maya Kodeih, Toronto (CA); Sylvia Gedge, Burlington (CA)

(21) Appl. No.: 17/868,580

(22) Filed: Jul. 19, 2022

Related U.S. Application Data
(60) Provisional application No. 63/255,138, filed on Oct. 13, 2021.

(51) Int. Cl. G06F 16/535; G06F 16/58; G06N 5/02; G06K 9/62

(52) U.S. Cl. CPC G06F 16/535; G06F 16/5866; G06N 5/022; G06K 9/6259

(57) ABSTRACT

Computer-implemented systems and methods for integrating knowledge from a plurality of data sources are provided. An example method involves operating at least one processor to store a unified split data structure specific to a user profile for derived knowledge and receive a request for knowledge from a computing device associated with the user profile. In response to receiving the request, the at least one processor is operable to retrieve knowledge from the unified split data structure based on the request and display the retrieve knowledge at the computing device.

### CROSS-REFERENCE TO RELATED APPLICATIONS

This application claims the benefit of U.S. Provisional Patent Application No. 63/255,138 filed on Oct. 13, 2021. The complete disclosure of U.S. Provisional Patent Application No. 63/255,138 is incorporated herein by reference for all purposes.

### FIELD

The described embodiments relate to systems and methods for data management. In some example embodiments, the systems and methods can relate to integrating knowledge from a plurality of data sources.

### BACKGROUND

In today's digital age, increasing amounts of data is generated but data management continues to have many challenges. Conventional data management methods can involve tagging and indexing data sources to allow the data source to be located and retrieved. Tagging and indexing typically requires at least some manual input to create the tags and/or indexes. Furthermore, data is rarely integrated in conventional data management methods.

Data integration relates to combining data from multiple sources and also requires at least some manual input. For example, security approval may be required to access the data sources. Data integration also involves connecting to the data sources, mapping the data sources, and tagging the data, each of which can also require manual input. The result of data integration is often large copies of the integrated data stored in ever increasingly large data warehouses.

However, being copies of the original data, integrated data can be rigid and difficult to view and use. Furthermore, any updates or changes would require manual input. Manual input in data management is not trivial and typically requires skilled developers.

### SUMMARY

In accordance with a broad aspect, there is provided a system for integrating knowledge from a plurality of data sources. The system includes a communication component to provide access to the plurality of data sources via a network; and at least one processor in communication with the communication interface. The at least one processor is operable to store a unified split data structure specific to a user profile for derived knowledge. The unified split data structure can be stored in a storage component within the network. The at least one processor can be further operable to receive a request for knowledge from a computing device associated with the user profile; in response to receiving the request, retrieve knowledge from the unified split data structure based on the request; and display the retrieved knowledge at the computing device.

In at least one embodiment, the at least one processor can be operable to, for each derived knowledge, store a knowledge label and data source location data in the unified split data structure. The knowledge label can be indicative of the derived knowledge. The data source location data can be indicative of a location of the data source accessible via the network.

In at least one embodiment, the at least one processor can be operable to use the unified split data structure to select knowledge that corresponds to the request as the retrieved knowledge and obtain the data source location data of the retrieved knowledge. The at least one processor can be further operable to access the data source of the retrieved knowledge based on the data source location data.

In at least one embodiment, the at least one processor can be further operable to, for each derived knowledge, store knowledge location data in the unified split data structure, the knowledge location data being indicative of a location of the knowledge within the data source.

In at least one embodiment, the at least one processor can be operable to: access the plurality of data sources; and derive knowledge from the plurality of data sources.

In at least one embodiment, the at least one processor can be operable to: receive at least one data source from a computing device associated with the user profile; and store the at least one data source in a storage component accessible via the network.

In at least one embodiment, the at least one processor can be operable to: identify one or more potential data sources accessible via the network; prioritize the one or more potential data sources for processing; access the potential data sources in order of priority; and for each data source accessed, sequence the data source.

In at least one embodiment, the at least one processor can be operable to, for each data source: generate a representation of the data source; derive knowledge from the representation of the data source; and generate at least one knowledge label indicative of knowledge derived from the representation of the data source. The representation can consist of images, text, or a combination of images and text.

In at least one embodiment, the at least one processor can be operable to, for each image of the representation of the data source, divide the image into a plurality of image portions; and expand each image portion of the plurality of image portions. The at least one processor can be further operable to derive knowledge from the expanded image portions of the plurality of image portions.

In at least one embodiment, the at least one processor can be operable to use at least one of spatial optimization or grid optimization to divide the image into a plurality of image portions.

In at least one embodiment, the at least one processor can be operable to: derive at least one potential knowledge from the representation of the data source; and, for each potential knowledge of the at least one potential knowledge, generate a potential knowledge label indicative of the potential knowledge; and determine whether to select the potential knowledge as the derived knowledge.

In at least one embodiment, the at least one processor can be operable to: display the at least one potential knowledge label at the computing device associated with the user profile; and receive user input for the at least one potential knowledge label from the computing device associated with the user profile. The user input can be used to determine whether to select the potential knowledge as the derived knowledge.

In at least one embodiment, the user input can include one of a group consisting of approval of the potential knowledge, modification of the potential knowledge, and at least one additional potential knowledge. The at least one processor can be operable to: in response to receiving approval of the potential knowledge, select the potential knowledge as the derived knowledge; in response to receiving a modification of the potential knowledge, use the modification of the potential knowledge as the derived knowledge; and in response to receiving additional potential knowledge, use the potential knowledge and the at least one additional potential knowledge as the derived knowledge.

In at least one embodiment, the at least one processor can be operable to derive the at least one potential knowledge based on user input previously received for existing derived knowledge.

In at least one embodiment, the at least one processor can be operable to, for each potential knowledge of the at least one potential knowledge, generate an importance measure for the potential knowledge, the importance measure being used to determine whether to select the potential knowledge as the derived knowledge.

In at least one embodiment, the importance measure for the potential knowledge is based at least in part on the user profile and all terms used by any user profile.

In at least one embodiment, the at least one processor can be operable to, for each potential knowledge of the at least one potential knowledge: determine whether the importance measure for the potential knowledge exceeds a pre-determined importance threshold value; and if the importance measure exceeds the pre-determined importance threshold value, select the potential knowledge as the derived knowledge.

In at least one embodiment, the at least one processor can be operable to use at least one of pattern-detection analysis, spatial algorithms, non-suppression analysis, or object-detection analysis to derive knowledge from the representation of the data source.

In accordance with another broad aspect, there is provided a computer-implemented method of integrating knowledge from a plurality of data sources. The method involves operating at least one processor to: store a unified split data structure specific to a user profile for derived knowledge; receive a request for knowledge from a computing device associated with the user profile; in response to receiving the request, retrieve knowledge from the unified split data structure based on the request; and display the retrieved knowledge at the computing device.

In at least one embodiment, the method can involve operating the at least one processor to, for each derived knowledge, store a knowledge label and data source location data in the unified split data structure. The knowledge label can be indicative of the derived knowledge. The data source location data can be indicative of a location of the data source accessible via the network.

In at least one embodiment, the method can involve operating the at least one processor to use the unified split data structure to: select knowledge that corresponds to the request as the retrieved knowledge; and obtain the data source location data of the retrieved knowledge. The method can further involve operating the at least one processor to access the data source of the retrieved knowledge based on the data source location data.

In at least one embodiment, the method can involve operating the at least one processor to, for each derived knowledge, store knowledge location data in the unified split data structure. The knowledge location data can be indicative of a location of the knowledge within the data source.

In at least one embodiment, the method can involve operating the at least one processor to access the plurality of data sources; and derive knowledge from the plurality of data sources.

In at least one embodiment, the method can involve operating the at least one processor to: receive at least one data source from a computing device associated with the user profile; and store the at least one data source in a storage component accessible via the network.

In at least one embodiment, the method can involve operating the at least one processor to: identify one or more potential data sources accessible via the network; prioritize the one or more potential data sources for processing; access the potential data sources in order of priority; and for each data source accessed, sequence the data source.

In at least one embodiment, the method can involve operating the at least one processor to, for each data source: generate a representation of the data source, the representation consisting of images, text, or a combination of images and text; derive knowledge from the representation of the data source; and generate at least one knowledge label indicative of knowledge derived from the representation of the data source.

In at least one embodiment, the method can involve operating the at least one processor to: for each image of the representation of the data source, divide the image into a plurality of image portions; and expand each image portion of the plurality of image portions. The method can further involve operating the at least one processor to derive knowledge from the expanded image portions of the plurality of image portions.

In at least one embodiment, the method can involve operating the at least one processor to use at least one of spatial optimization or grid optimization to divide the image into a plurality of image portions.

In at least one embodiment, the method can involve operating the at least one processor to: derive at least one potential knowledge from the representation of the data source; for each potential knowledge of the at least one potential knowledge, generate a potential knowledge label indicative of the potential knowledge; and determine whether to select the potential knowledge as the derived knowledge.

In at least one embodiment, the method can involve operating the at least one processor to: display the at least one potential knowledge label at the computing device associated with the user profile; and receive user input for the at least one potential knowledge label from the computing device associated with the user profile. The user input can be used to determine whether to select the potential knowledge as the derived knowledge.

In at least one embodiment, the user input can include one of a group consisting of approval of the potential knowledge, modification of the potential knowledge, and at least one additional potential knowledge. The method can involve operating the at least one processor to: in response to receiving approval of the potential knowledge, select the potential knowledge as the derived knowledge; in response to receiving a modification of the potential knowledge, use the modification of the potential knowledge as the derived knowledge; and in response to receiving additional potential knowledge, use the potential knowledge and the at least one additional potential knowledge as the derived knowledge.

In at least one embodiment, the method can involve operating the at least one processor to derive the at least one potential knowledge based on user input previously received for existing derived knowledge.

In at least one embodiment, the method can involve operating the at least one processor to, for each potential knowledge of the at least one potential knowledge, generate an importance measure for the potential knowledge. The importance measure can be used to determine whether to select the potential knowledge as the derived knowledge.

In at least one embodiment, the importance measure for the potential knowledge can be based at least in part on the user profile and all terms used by any user profile.

In at least one embodiment, the method can involve operating the at least one processor to, for each potential knowledge of the at least one potential knowledge: determine whether the importance measure for the potential knowledge exceeds a pre-determined importance threshold value; and if the importance measure exceeds the pre-determined importance threshold value, select the potential knowledge as the derived knowledge.

In at least one embodiment, the method can involve operating the at least one processor to use at least one of pattern-detection analysis, spatial algorithms, non-suppression analysis, or object-detection analysis to derive knowledge from the representation of the data source.

### BRIEF DESCRIPTION OF THE DRAWINGS

Several embodiments will now be described in detail with reference to the drawings, in which:

FIG. 1 is a block diagram of a knowledge integration system in accordance with an example embodiment;

FIG. 2A is a flowchart of a method of deriving knowledge with user input, in accordance with an example embodiment;

FIG. 2B is a flowchart of another method of deriving knowledge with user input, in accordance with another example embodiment;

FIG. 2C is a flowchart of another method of deriving knowledge with user input, in accordance with another example embodiment;

FIG. 3A is a flowchart of another method of deriving knowledge with user input, in accordance with another example embodiment;

FIG. 3B is a flowchart of another method of deriving knowledge with user input, in accordance with another example embodiment;

FIG. 4 is a flowchart of a method of integrating knowledge, in accordance with an example embodiment;

FIG. 5 is a flowchart of a method of integrating knowledge, in accordance with another example embodiment;

FIG. 6A are illustrations of example data structures, in accordance with an example embodiment;

FIG. 6B is an illustration of a knowledge relationship dataset for the data sources of FIG. 6A, in accordance with an example embodiment; and

FIG. 6C is an illustration of another knowledge relationship data for a plurality of data sources, in accordance with another example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to methods (and associated systems configured to implement the methods) of data management and data integration. Data integration is directed to combining data from a plurality of data sources.

Traditional methods of data integration involves tagging documents with additional information (i.e., “tags”) and indexing documents. However, creating tags and indexes can be a manual process, requiring a data analyst or developer to review data, identify connections between data to define an appropriate tag, and create and apply the tag.

Furthermore, data integration often involves creating copies of data. First, with ever growing volumes of data, increasingly larger data warehouses are required to store data integrations. Second, such copies disconnect integrated data from the original source data, which may change with time. The connections or relationships between data can also change with time. As such, data integration that relies on tagging and creating copies of data can become static and rigid over time.

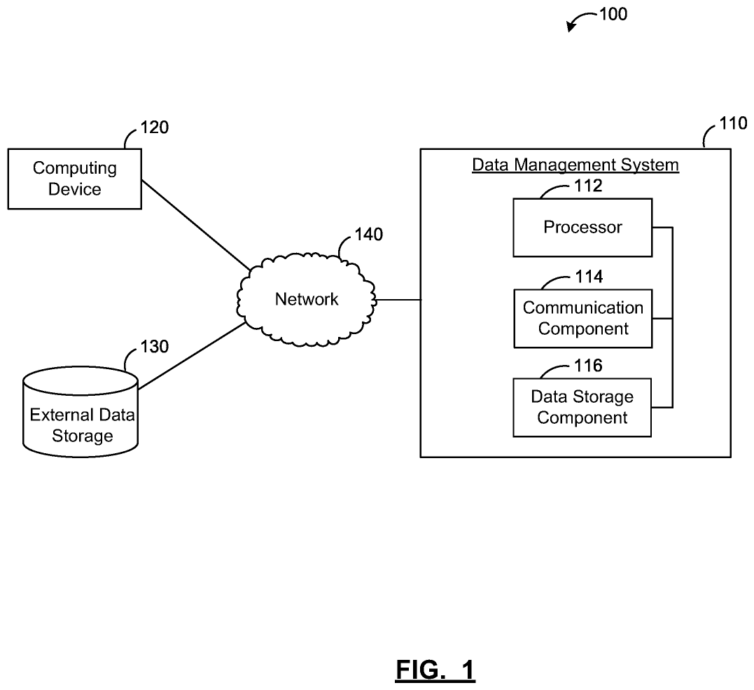

Reference is now made to FIG. 1, which illustrates a block diagram 100 of components interacting with an example data management system 110. As shown in FIG. 1, the data management system 110 is in communication with a computing device 120 and an external data storage 130 via a network 140.

The data management system 110 includes a management processor 112, a management communication component 114, and a management data storage component 116. The data management system 110 can be provided on one or more computer servers that may be distributed over a wide geographic area and connected via the network 140.

The data management system 110 can perform various functions related to electronic document management and data integration. For example, the data management system 110 can develop a user profile from information provided at the computing device 120. The data management system 110 can receive a data source, such as an electronic CAD file, from the computing device 120 and store the data source in external data storage 130. The data management system 110 can also access a data source stored in external data storage 130 and transmit the data source to the computing device 120.

The data management system 110 can also locate data sources accessible within network 140 and sequence the located data sources. For example, the data management system 110 can receive a connection or network information and the data management system 110 can locate data sources on a file server, database, or data warehouses. To locate data sources accessible within network 140, the data management system 110 can use various security and soft penetration techniques to identify what is accessible within the network. The data management system 110 can navigate directory structures, file properties, and database schemas to fingerprint databases, file servers, and data warehouses.

The data management system 110 can process data sources. For each data source, the data management system 110 can determine the data structure of the data source. In at least one embodiment, the data management system 110 can extract information from the data sources, or derive knowledge from the data sources, based on the data structure. The data management system 110 can build data structures based on knowledge derived from the data sources. In at least one embodiment, the data management system 110 can operate a graph engine to build such data structures based on knowledge derived from the data sources. The data management system 110 can receive and process requests for information from the data sources.

It will be appreciated that there can be a wide variety of data sources. Data sources can include, but is not limited to electronic files (i.e., electronic documents, portable document format (.pdf), images or pictures, text, computer-aided design (.cad)), data warehouses, websites, databases, file servers, hashes, application program interfaces (APIs). Furthermore, data sources need not be located within the same IT infrastructure as the data management system 110. That is, data sources may be located within third party networks.

The data management system 110 can determine that a data source has an unknown data structure. The data management system 110 can define new data structures. In at least one embodiment, the data management system 110 can receive user input to help define a new data structure. The data management system 110 can also make suggestions about the new data structure definition.

The management processor 112, the management communication component 114, and the management data storage component 116 can be combined into a fewer number of components or can be separated into further components. The management processor 112, the management communication component 114, and the management data storage component 116 may be implemented in software or hardware, or a combination of software and hardware.

The management processor 112 can operate to control the operation of the data management system 110. The management processor 112 can initiate and manage the operations of each of the other components within the data management system 110. The management processor 112 may be any suitable processors, controllers, digital signal processors, or graphics processing units (GPUs) that can provide sufficient processing power depending on the configuration, purposes and requirements of the data management system 110. In some embodiments, the management processor 112 can include more than one processor with each processor being configured to perform different dedicated tasks.

The management communication component 114 may include any interface that enables the data management system 110 to communicate with other devices and systems. In some embodiments, the management communication component 114 can include at least one of a serial port, a parallel port or a USB port. The management communication component 114 may also include at least one of an Internet, Local Area Network (LAN), Ethernet, Firewire, modem or digital subscriber line connection. Various combinations of these elements may be incorporated within the management communication component 114.

For example, the management communication component 114 may receive input from various input devices, such as a mouse, a keyboard, a touch screen, a thumbwheel, a track-pad, a track-ball, a card-reader, voice recognition software and the like depending on the requirements and implementation of the data management system 110.

The management data storage component 116 can include RAM, ROM, one or more hard drives, one or more flash drives or some other suitable data storage elements such as disk drives, etc. Similar to the management data storage component 116, the external data storage 130 can also include RAM, ROM, one or more hard drives, one or more flash drives or some other suitable data storage elements such as disk drives, etc.

The management data storage component 116 and the external data storage 130 can also include one or more databases for storing data sources, user profiles, and data structures. In at least one embodiment, the management data storage component and the external data storage 130 can store a unified split data structure.

The computing device 120 can include any networked device operable to connect to the network 140. A networked device is a device capable of communicating with other devices through a network such as the network 140. A networked device may couple to the network 140 through a wired or wireless connection. Although only one computing device 120 is shown in FIG. 1, it will be understood that more computing devices 120 can connect to the network 140.

The computing device 120 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

The computing device 120 can be associated with a user profile. The user can provide authentication credentials to access the network 140 and transmit data to the data management system 110.

The network 140 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX, Ultra-wideband, Bluetooth®), SS7 signaling network, fixed line, local area network, wide area network, and others, including any combination of these, capable of interfacing with, and enabling communication between, the data management system 110, the computing device 120 and the external data storage 130.

It will be understood that some components of FIG. 1, such as components of the data management system 110 or the external data storage 130, can be implemented in a cloud computing environment.

In at least one embodiment, the data management system 110 can create and maintain a unified split data structure for managing knowledge derived from a plurality of data structures. The data management system 110 can store, in the unified split data structure, data source location data that indicates the location of a data source containing knowledge. For example, a data source may be located on an external data storage, such as external data storage 130, accessible via network 140. The data management system 110 can also store, in the unified split data structure, knowledge location data that indicates the location of data that pertains to knowledge within a data source. In at least one embodiment, knowledge location data can include pointers and references to data. By storing data source location data and knowledge location data, the unified split data structure does not require storage of copies of data that the knowledge pertains to.

In at least one embodiment, headers of the unified split data structure can be dynamic. Furthermore, by using pointers and references to data as the knowledge location data, the derived knowledge managed by the unified split data structure is also dynamic.

In at least one embodiment, the unified split data structure can be specific to a user profile. The data management system 110 can create and maintain user profiles. The data management system 110 can store, in user profiles, user data provided in response to questions posed by the data management system 110. For example, user data can relate to an industry and a job position that a user works in. User data can also relate to demographics. Prior to receiving any user data, a user profile can be a default user profile. The user profile data can be updated overtime as the user interacts with the data management system 110.

In at least one embodiment, the data management system 110 can populate knowledge in the unified split data structure by accessing a plurality of data sources and deriving knowledge from the plurality of data sources. In at least one embodiment, the data management system 110 can access the plurality of data sources by identifying one or more potential data sources accessible from the network, prioritizing the one or more potential data sources for processing, and accessing the potential data sources in order or priority. For each data source that is accessed, the data management system 110 can sequence the data source as having been accessed.

In at least one embodiment, the data management system 110 can populate knowledge in the unified split data structure by receiving a data source from a computing device, such as computing device 120. The data management system 110 can store the data source in external data storage 130. By storing the data source in external data storage 130, the data source can be accessed thereafter.

In at least one embodiment, the data management system 110 can determine a data structure for the data source. The data management system 110 can derive knowledge from the data source based on the data structure. In the event that the data management system 110 does not recognize the data structure, the data management system 110 can define a new data structure based on the data source. In at least one embodiment, the data management system 110 can operate a graph engine to identify relationships within a dataset and use the data relationships to build a new data structure. The data management system 110 can generate suggestions for the new data structure and receive user input on the suggestions.

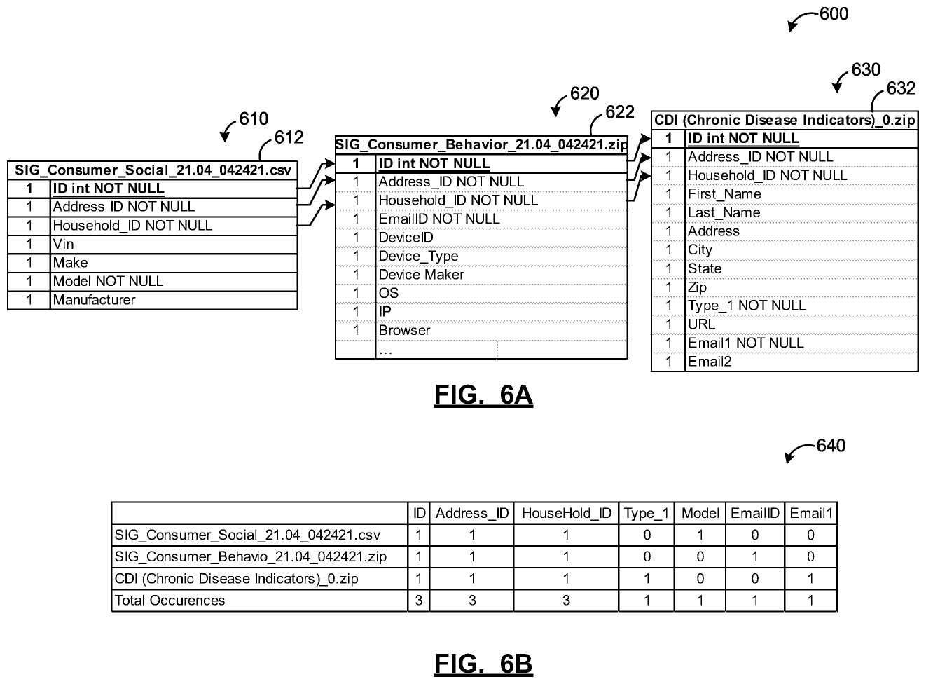

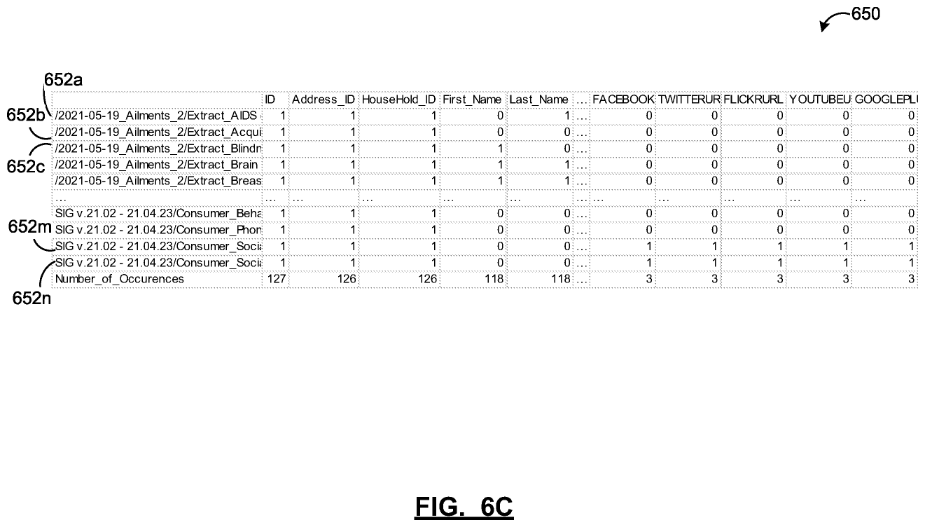

Example data structures 610, 620, and 630, in accordance with another example embodiment, are shown in illustration 600 of FIG. 6A. As can be seen in illustration 600, each of data structures 610, 620, and 630 relate to a respective data source 612, 622, and 632.

For example, the data management system 110 can determine that the data structure for data source 612 includes “ID” data, “Address ID” data, “Household_ID” data, “Vin” data, “Make” data, “Model” data, and “Manufacturer” data. Similarly, the data management system 110 can determine that the data structure for data source 622 includes “ID” data, “Address ID” data, “Household_ID” data, and “EmailID” data, “DeviceID” data, “Device_Type” data, “Device Maker” data, “OS” data, “IP” data, and “Browser” data and the data structure for data source 632 includes “ID” data, “Address ID” data, “Household_ID” data, “First_Name” data, “Last_Name” data, “Address” data, “City” data, “State” data, “Zip” data, “Type_1” data, “URL” data, “Email1” data, and “Email2” data.

Based on the data structure of the data source, the data management system 110 can extract information that corresponds to the data structure. For example, with data source 612, the data management system 110 can extract information that corresponds to the “ID” data, “Address ID” data, “Household_ID” data, and “Model” data. However, the data management system 110 may not locate information that corresponds to the “Vin” data, “Make” data, and “Manufacturer” data in data source 612. Likewise, with data source 612, the data management system 110 can extract information that corresponds to the “ID” data, “Address ID” data, “Household_ID” data, and “EmailID” data. However, the data management system 110 may not locate information that corresponds to the “DeviceID” data, “Device_Type” data, “Device Maker” data, “OS” data, “IP” data, and “Browser” data in data source 622. Also, the data management system 110 can extract information that corresponds to the “ID” data, “Address ID” data, “Household_ID” data, “Type_1” data, and “Email1” data but may not locate information that corresponds to “First_Name” data, “Last_Name” data, “Address” data, “City” data, “State” data, “Zip” data, “URL” data, and and “Email2” data in data source 632.

In at least one embodiment, the data management system 110 can derive knowledge from a data source by generating a representation of the data source. For example, a data source can be an electronic document and the data management system 110 can convert the electronic document into images, text, or a combination of images and text. The data management system 110 can derive knowledge from the representation of the data source—that is, the combination of images and text. After deriving knowledge from the representation of the data source, the data management system 110 can generate a knowledge label for the knowledge.

Images can include unique aspects that complicate traditional extraction techniques. To derive knowledge from images, the data management system 110 can divide the image into a plurality of image portions. For example, the data management system 110 can grid the image into smaller image portions. The data management system can use spatial optimization, grid optimization, or spatial optimization and grid optimization to divide the image into a plurality of image portions. The plurality of image portions can have substantially the same size, substantially the same dimensions (including shape), or substantially the same size and dimensions.

The data management system 110 can derive knowledge from each image portion of the plurality of image portion successively. In at least one embodiment, the data management system 110 can prioritize each image portion of the plurality of image portions and derive knowledge from each image portion in order of priority. The data management system 110 can expand, or zoom in, each image portion to derive knowledge from the expanded image portion.

In at least one embodiment, deriving knowledge from an image portion (herein referred to as a “subject image portion”) can include consideration of neighbouring image portions. That is, objects in a subject image portion and in neighbouring image portions can be examined to derive knowledge for the subject image portion. Objects can include layers, pixel objects, or text data. In at least one embodiment, a neighbouring image portion can share at least one common edge with the subject image portion.

To process the plurality of image portions, the data management system 110 can identify related image portions and apply similar algorithms to related image portions. The data management system 110 can determine whether an image portion is related to another image portion (herein referred to as a “reference image portion”) based on whether the image portion is a neighbouring image portion and whether the image portion has similar objects as the reference image portion, such as layers, pixel objects, or text data.

In at least one embodiment, a measure of similarity of the objects of the image portion and the reference image portion is determined. The measure of similarity can relate to any one of layers, pixel objects, or text data, or any combination thereof. The measure of similarity can be compared with a similarity threshold. For example, the similarity threshold can be 80%. When the measure of similarity is greater than the similarity threshold, the image portion can be considered related to the reference image portion. Algorithms for deriving knowledge from the reference image portion can also be applied to the related image portion.

In at least one embodiment, the identification of related image portions can be iterative. For example, the related image portion can now be used as a reference image portion to locate additional related image portions. A second image portion may be identified as being a related image portion but the second image portion may not share a common edge with the reference image portion originally used to identify the first image portion.

The data management system 110 can use pattern-detection analysis, spatial algorithms, non-suppression analysis, or object-detection analysis to derive knowledge from the representation of the data source. In at least one embodiment, the data management system 110 can use named entity recognition (NER) extraction to derive knowledge from the representation of the data sources including text.

In at least one embodiment, the data management system 110 can derive at least one potential knowledge from the representation of the data source. For example, the data management system 110 can derive a plurality of potential knowledge from the combination of images and text for an electronic document. For each potential knowledge that has been derived, the data management system 110 can generate a potential knowledge label indicative of the potential knowledge derived.

The data management system 110 can then determine whether to select the potential knowledge as the derived knowledge for an electronic document. That is, the data management system 110 can select a subset of potential knowledge to use as the derived knowledge for an electronic document. The data management system 110 can extract a plurality of potential knowledge and determine whether to retain each potential knowledge as derived knowledge for the electronic document. It should be noted that the subset of potential knowledge to use as the derived knowledge may be an empty subset. That is, the data management system 110 can determine that not to retain any of potential knowledge as derived knowledge for the electronic document.

To determine whether to select the potential knowledge as derived knowledge, the data management system 110 can display the at least one potential knowledge label and the data source at the computing device. In at least one embodiment, a portion of the data source from which the potential knowledge is derived is displayed at the computing device. The portion of the data source displayed at the computing device can be the expanded image portion of the representation of the data source, the image portion of the representation of the data source, or the data source itself.

A user at the computing device can review the knowledge label displayed at the computing device and provide input on whether or not to accept or approve the potential knowledge as derived knowledge for the data source. For example, a plurality of potential knowledge can be displayed, and the user input can relate to a selection of potential knowledge to reject. Alternatively, the user input can relate to a selection of potential knowledge to accept. In at least one embodiment, the user input can provide additional potential knowledge. In at least one embodiment, the user input can modify the potential knowledge derived by the data management system 110.

In at least one embodiment, the data management system 110 can learn from the user input received. For example, when user input relates to accepting potential knowledge without modification nor additions, the data management system 110 can use the same algorithms used for deriving the accepted potential knowledge for other similar data sources, image portions, and/or expanded image portions.

In at least one embodiment, the data management system 110 can generate an importance measure for the potential knowledge and use the importance measure to determine whether to select the potential knowledge as the derived knowledge. In at least one embodiment, the importance measure can be based on the user profile associated with the user. In at least one embodiment, the importance measure can be based on all terms used by any user profile within the data management system 110. In at least one embodiment, the importance measure can be based on both the user profile and all terms used by any user profile within the data management system 110.

The importance measure can be used to determine whether to select the potential knowledge as the derived knowledge. For example, the importance threshold for each potential knowledge can be compared against a pre-determined importance threshold value. If the importance measure of a potential knowledge exceeds the pre-determined importance threshold value, the potential knowledge can be retained as derived knowledge. If the importance measure of a potential knowledge does not exceed the pre-determined importance threshold value, the potential knowledge can be discarded.

Alternatively, the data management system 110 can select the potential knowledge having the highest importance measure as derived knowledge. Other methods of using the importance measure to select the potential knowledge are possible. For example, some methods can be based on models for fungal growth, human behaviour, neural networks, marketing, and logistics. Furthermore, the selection of the type of method can be based on a category that the potential knowledge relates to. For example, the potential knowledge can include a hash reference and accordingly, a marketing-based model can be used to select the potential knowledge. Potential knowledge can also relate to other categories, such as technical culture, technical stacks, or human sensitive knowledge.

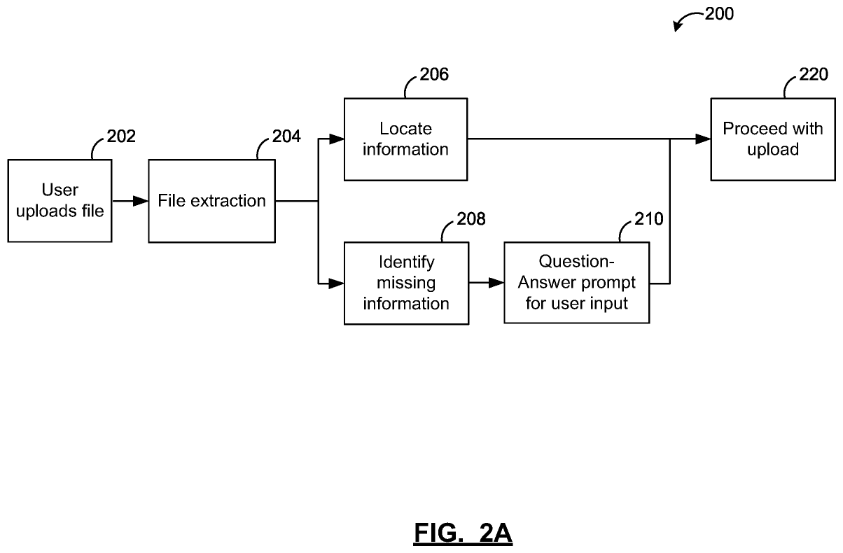

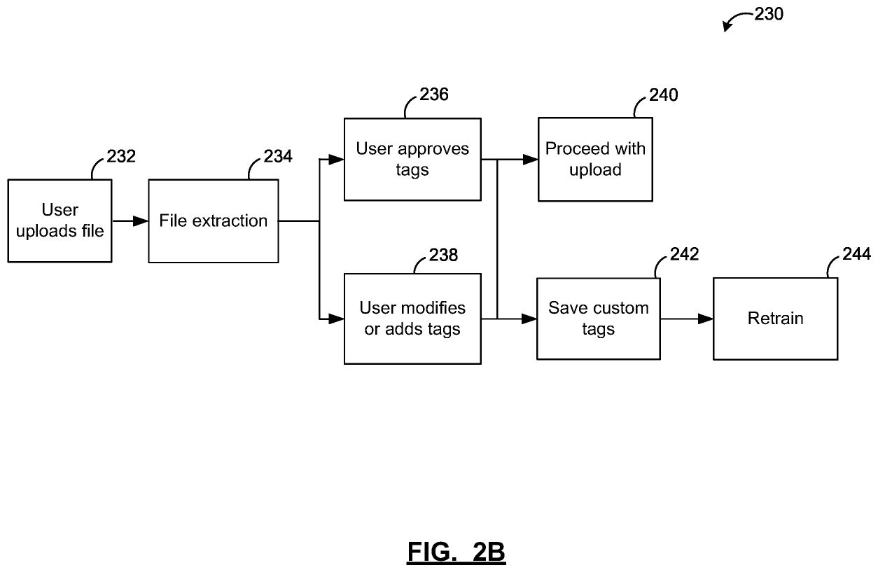

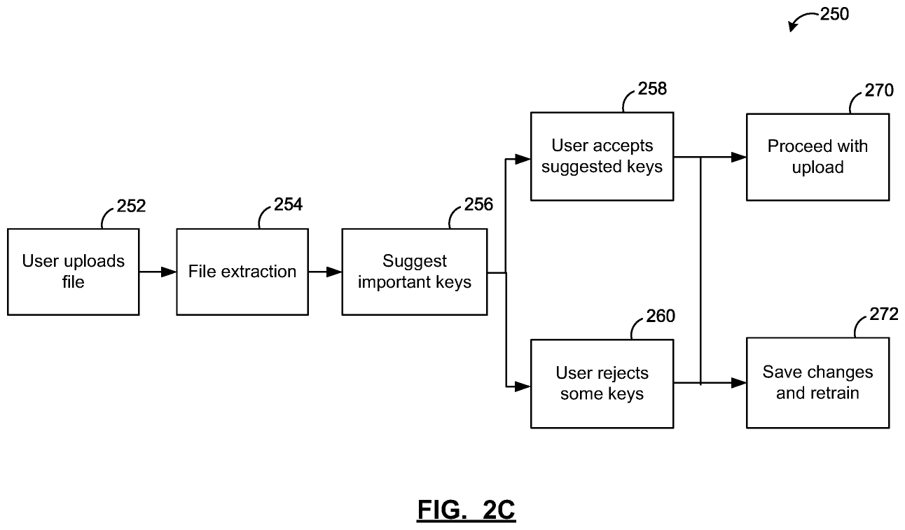

Reference is now made to FIG. 2A, which illustrates a flowchart of a method 200 of deriving knowledge with user input, in accordance with an example embodiment. A data management system, such as data management system 110 having a processor 112 can be configured to implement the method 200.

Method 200 can begin at 202 with a user at a computing device, such as computing device 120, uploading a data source, such as an electronic file. The data source can be transmitted from computing device 120 to data management system 110 via a network, such as network 140. In at least one embodiment, uploading a data source can involve the user dragging and dropping files within a graphical user interface. In at least one embodiment, 202 can involve providing a connection or network information for data management system 110 to access a plurality of data sources.

At 204, data management system 110 can process the electronic file. In at least one embodiment, the electronic file can be an electronic document containing text data. Text data can include structured string text or unstructured text. Data management system 110 can extract information from the text data using NER extraction. Other extraction techniques are possible.

At 206, data management system 110 can use information located by NER as derived knowledge. Data management system 110 can generate knowledge labels for the derived knowledge.

In some cases, NER may not identify all information. At 208, data management system 110 can identify missing information not located by NER. For example, referring now to FIG. 6B, NER located “ID” data, “Address ID” data, “Household_ID” data in each of data sources 612, 622, and 632. However, additional data was not located in each of data sources 612, 622, and 632. For example, in data source 612, “Vin” data, “Make” data, and “Manufacturer” data were not identified (i.e., missing information).

At 210, the missing information can be displayed to the user at computing device 120. In at least embodiment, a question-answer prompt can be displayed to receive the identified missing information. The contents of the data source can also be displayed at the computing device 120 to assist the user in identifying the missing information. The computing device 120 can receive user input in the form of text data and transmit the user input to data management system 110. The user input received at 210 can be used as derived knowledge. Data management system 110 can generate knowledge labels for the user input.

After generating knowledge labels for the user input 210, as well as the information located by the extraction at 206, data management system 110 can proceed with uploading the electronic file at 220. Data management system 110 can store the electronic file in an external data storage, such as external data storage 130, and store the knowledge labels for located information in a unified split data structure specific to the user profile associated with computing device 120.

Reference is now made to FIG. 2B, which illustrates a flowchart of another method 230 of deriving knowledge with user input, in accordance with another example embodiment. Similar to method 200, method 230 can be implemented by a data management system, such as data management system 110 having a processor 112.

Method 230 can begin at 232 with a user at a computing device, such as computing device 120, uploading a data source, such as an electronic file. The data source can be transmitted from computing device 120 to data management system 110 via a network, such as network 140.

At 234, data management system 110 can process the electronic file. In at least one embodiment, the electronic file be an electronic document containing text data and image data. Text data can include structured string text or unstructured text. Data management system 110 can extract information from the electronic file using named entity recognition (NER) extraction. Other extraction techniques are possible.

Data management system 110 can use information extracted by named entity recognition extraction as potential knowledge. Data management system 110 can generate potential knowledge labels for the potential knowledge. In at least one embodiment, the potential knowledge labels can include tags. That is, the potential knowledge label can include a reference to extracted information. The tags can be displayed to the user at computing device 120. In at least embodiment, the contents of the data source corresponding to the tags can be displayed at the computing device 120.

At 236, computing device 120 can receive user input indicating approval of tags. Data management system 110 can use the potential knowledge corresponding to the approved tags as derived knowledge.

In some cases, the user may not approve of a tag. Instead, the user may modify or add a tag. At 238, computing device 120 can receive user input indicating a custom tag (e.g., modification of a knowledge label or additional knowledge label).

Data management system 110 can use the approved tags along with the custom tags with the potential knowledge as derived knowledge and proceed with uploading the electronic file at 240. Data management system 110 can store the electronic file in an external data storage, such as external data storage 130, and store the approved tags and the custom tags for derived knowledge in a unified split data structure specific to the user profile associated with computing device 120.

At 242, data management system 110 can also store the custom tags for future use in the extraction at 234. That is, identifying a data source similar to the present data source, the file extraction will also seek to identify the custom tags in the data source.

At 244, data management system 110 can be retrained using new data, such as the custom tags. For example, in cases where the data management system 110 operates a graph engine to identify data relationships, the graph engine can be retrained using the custom tags received at 238.

Reference is now made to FIG. 2C, which illustrates a flowchart of another method 250 of deriving knowledge with user input, in accordance with another example embodiment. Similar to methods 200 and 230, method 250 can be implemented by a data management system, such as data management system 110 having a processor 112.

Method 250 can begin at 252 with a user at a computing device, such as computing device 120, uploading a data source, such as an electronic file. The data source can be transmitted from computing device 120 to data management system 110 via a network, such as network 140.

At 254, data management system 110 can process the electronic file. In at least one embodiment, the electronic file be an electronic document containing text data and image data. Text data can include structured string text or unstructured text. Data management system 110 can extract information from the electronic file. In at least one embodiment, extraction at 254 can include named entity recognition extraction. Other extraction techniques are possible.

At 256, data management system 110 can use information extracted as potential knowledge. Data management system 110 can generate potential knowledge labels for the potential knowledge. In at least one embodiment, the potential knowledge labels can include keys. That is, the potential knowledge label can include extracted information. The keys can be displayed to the user at computing device 120 as suggestions. In at least embodiment, the contents of the data source corresponding to the keys can be displayed at the computing device 120.

In at least one embodiment, data management system 110 can determine an importance measure for each of the potential knowledge and only suggest a portion of the keys, based on the corresponding importance measure. For example, data management system 110 can determine whether the importance measure exceeds a pre-determined importance threshold value. If the importance measure exceeds the pre-determined importance threshold value, the key is important and data management system 110 can display the important keys to the user at the computing device 120 as suggestions.

At 258, computing device 120 can receive user input indicating approval of suggested keys. Data management system 110 can use the potential knowledge corresponding to the approved keys as derived knowledge.

At 270, data management system 110 can proceed with uploading the electronic file. Data management system 110 can store the electronic file in an external data storage, such as external data storage 130, and store the approved keys for derived knowledge in a unified split data structure specific to the user profile associated with computing device 120.

In some cases, the user may not approve of a suggested key. At 260, computing device 120 can receive user input indicating a rejection of a key. Data management system 110 can proceed with uploading the electronic file at 270 with only the approved keys. That is, data management system 110 does not store the rejected keys for derived knowledge in the unified split data structure specific to the user profile associated with computing device 120.

At 272, data management system 110 can discard the rejected key so that it is not used in future extractions. Data management system 110 is retrained with the rejected keys being discarded, similar to 242. In some embodiments, retraining the data management system 110 can be fairly quick, in the order of 3 to 5 minutes.

Method 250 involves user input consisting of either approving or rejecting suggested keys. As such, user input in method 250 is used to filter keys suggested by data management system 110.

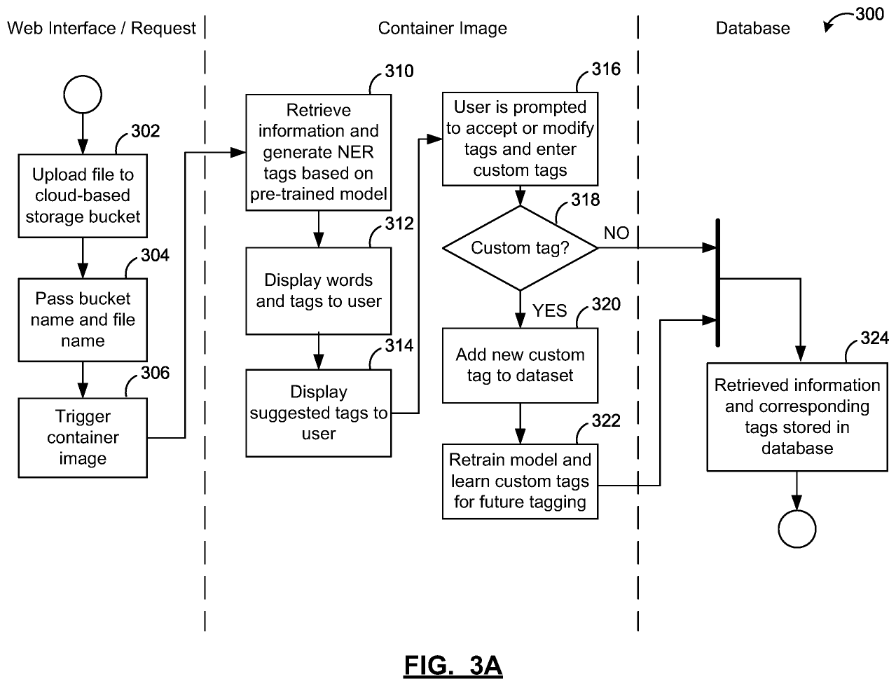

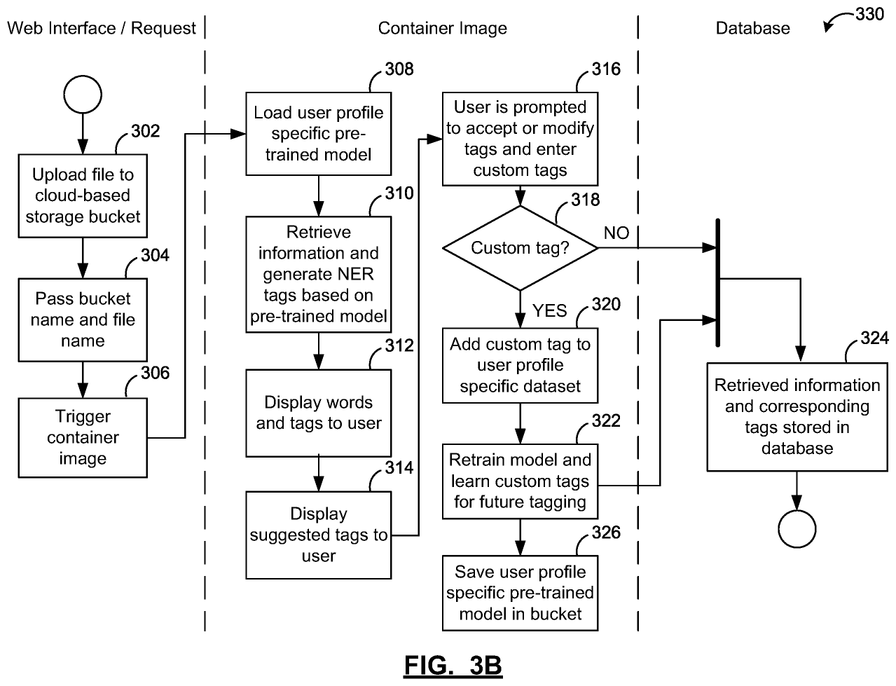

Reference is now made to FIG. 3A, which illustrates a flowchart of another example method 300 of deriving knowledge with user input, in accordance with another example embodiment. Similar to example methods 200, 230, and 250, example method 300 can be implemented by a data management system, such as data management system 110 having a processor 112. As shown in FIG. 3A, the data management system 110 can be a cloud computing environment including a container image and cloud-based storage.

Method 300 can begin at 302 with a user at a computing device, such as computing device 120, accessing a web interface to upload a data source, such as an electronic file. The data source can be transmitted from computing device 120 to a bucket of a cloud-based storage system. Step 302 can be similar to 202, 232, and 252 of methods 200, 230, and 250, respectively.

At 304, the bucket name and the file name can be transmitted to the cloud-based storage system. Using the file name and the bucket containing the electronic file uploaded at 302, a container image can be triggered at 306 for extracting the file and named entity recognition tagging. In at least one embodiment, the cloud-based storage system can trigger the container image.

At 310, the container image can retrieve information and generate named entity recognition tags. In at least one embodiment, 310 can be based on a pre-trained model such as a graph engine trained to identify data relationships. Step 310 can be similar to 204, 234, and 254 of methods 200, 230, and 250, respectively.

At 312, words, tags, or words and tags can be displayed to the user at computing device 120. In at least one embodiment, the words and tags can be displayed in a list format.

At 314, suggested tags can be displayed to the user at computing device 120 as suggested tags. Suggested tags can be a subset of the tags displayed at 312. Step 314 can be similar to 256 of method 250.

At 316, the user at computing device 120 can provide user input to approve suggested tags or provide custom tags (i.e., modified suggested tags or additional tags). The user input can be received in response to prompts displayed at the computing device 120 for the tags.

At 318, the container image can determine whether custom tags have been provided. If the user provides custom tags, method 300 proceeds to 320.

At 320, new custom tags can be added to the dataset. Furthermore, the model is retrained to learn the custom tags for future tagging at 322. In at least one embodiment, the graph engine can be retrained using the dataset including the custom tags. Steps 320 and 322 are similar to 242 and 244, respectively of method 230, and 272 of method 250.

At 324, the retrieved information and corresponding tags can be stored in the database. Step 324 is similar to 220, 240, and 270 of methods 200, 230, and 250.

Reference is now made to FIG. 3B, which illustrates a flowchart of another example method 330 of deriving knowledge with user input, in accordance with another example embodiment. Similar to example method 300, example method 330 can be implemented by a data management system 110 in a cloud computing environment including a container image and cloud-based storage.

Example method 330 is generally similar to example method 300, using similar reference numbers for similar steps. However, data management system 110 of method 330 supports a plurality of users. Accordingly, method 330 can include the container image loading a user profile specific pre-trained model at 308 after the container image is triggered and prior to file extraction at 310. As well, when the user provides a custom tag at 318, the custom tag is added to the user profile specific dataset at 320. Furthermore, after the model is retrained at 322, the user profile specific pre-trained model is saved to the bucket of 302 and 304, namely the bucket linked to the user profile.

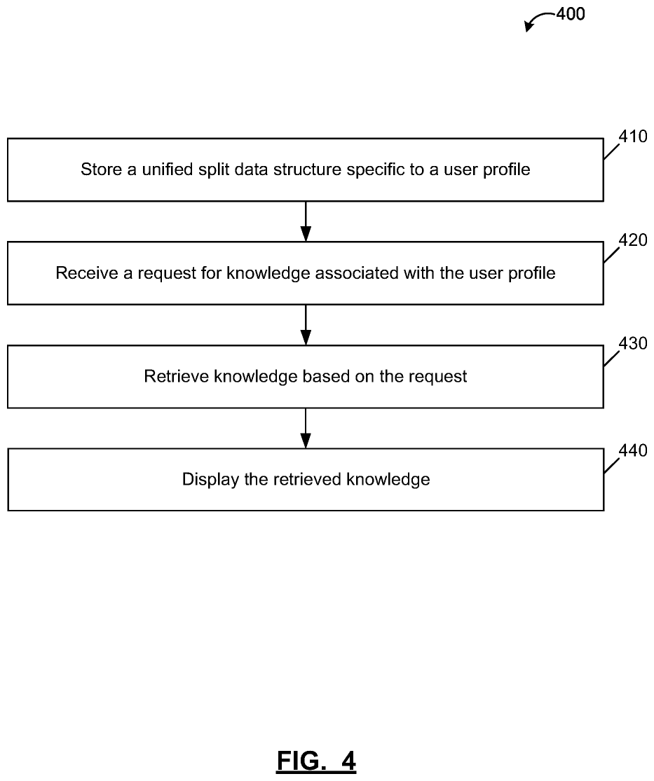

Reference is now made to FIG. 4, which illustrates a flowchart of a method 400 for integrating knowledge from a plurality of data sources. Method 400 can be implemented by a data management system, such as data management system 110.

Method 400 can begin at 410 with data management system 110 storing a unified split data structure specific to a user profile for derived knowledge. The unified split data structure can be stored in a storage component, such as external data storage 130, accessible via a network, such as network 140. The unified split data structure can be created using any one or more of methods 200, 230, 250, 300, and 330.

At 420, data management system 110 can receive a request for knowledge from computing device 120 associated with a user profile. The request can include one or more knowledge labels. In at least one embodiment, the request can be a search request. In at least one embodiment, the request can be a request to view document relationships and analysis.

At 430, in response to receiving the request, data management system 110 can retrieve knowledge from the unified split data structure based on the request. Data management system 110 can, based on the unified split data structure, locate data sources that satisfy the request. For example, for a request to search for particular knowledge, data management system 110 can locate data sources having knowledge labels that match the requested knowledge.

In at least one embodiment, data management system 110 can use the unified split data structure to: (i) select knowledge that corresponds to the request as the retrieved knowledge; and (ii) obtain data source location data of the retrieved knowledge. The data source location data can be indicative of a location of the data source accessible via the network. Data management system 110 can access the data source of the retrieved knowledge based on the data source location data.

In at least one embodiment, the selection of knowledge that corresponds to the request can be based on relationships between the knowledge. In at least one embodiment, the selection of knowledge that corresponds to the request can be based on prior requests, such as an acceptance or rejection of prior requests.

Reference is now made to FIG. 6B, which is an illustration of an example knowledge relationship dataset 640 for the data sources of FIG. 6A, in accordance with another example embodiment. Data management system 110 can generate the knowledge relationship dataset 640 based on the unified split data structure for the derived knowledge. For example, knowledge pertaining to “ID” data, “Address ID” data, “Household_ID” data were located in each of data sources 612, 622, and 632. However, knowledge pertaining to “Type_1” data and “Email1” data was only located in data source 632, “Model” data was only located in data source 612, and “EmailID” data was only located in data source 622. It is noted that knowledge pertaining to “EmailID” data of data source 622 is distinct from knowledge pertaining to “Email1” data and “Email2” data of data source 632.

In at least one embodiment, the selection of retrieved knowledge can be based on the number of occurrences of a type of knowledge located across all data sources, as shown in the knowledge relationship dataset 640. Furthermore, the knowledge relationship dataset can be specific to a user profile. In at least one embodiment, the selection of retrieved knowledge can be based on the number of occurrences located across all data sources for all user profiles. That is, the selection of retrieved knowledge can be based on the number of occurrences found in the knowledge relationship dataset 640 and all similar unified split data structures for other user profiles.

Reference is now made to FIG. 6C, which is an illustration of another example knowledge relationship dataset 650 for other data sources, in accordance with another example embodiment. Data management system 110 can extract information from the data sources 652a, 652b, 652c, . . . 652m, 652n (collectively referred to as 652) and identify types of data in each data source. In at least one embodiment, data management system 110 can also identify the data source on third-party websites, such as Facebook®, Twitter®, Flickr®, YouTube®, and Google®, etc. . . . . In at least one embodiment, third-party websites can be social media website. For example, data sources 652m and 652n, were located on each of Facebook®, Twitter®, Flickr®, YouTube®, and Google®.

In at least one embodiment, the selection of retrieved knowledge can be based on the number of occurrences of a type of knowledge located across all data sources, as well as the number of occurrences of the corresponding data source across third-party websites and noted in the knowledge relationship dataset 650. Again, the knowledge relationship dataset 650 can be specific to a user profile. In at least one embodiment, the selection of retrieved knowledge can be based on the number of occurrences located across all data sources, as well as the number of occurrences of the corresponding data source across third-party websites for all user profiles. That is, the selection of retrieved knowledge can be based on the number of occurrences noted in the knowledge relationship dataset 650 and all similar knowledge relationship datasets for other user profiles.

At 440, data management system 110 can display the retrieved knowledge at the computing device. In at least one embodiment, data management system 110 can receive user input based on the retrieved knowledge.

For example, the user may indicate acceptance or rejection of the retrieved knowledge. Data management system 110 can learn from the acceptance or rejection of retrieved knowledge. The selection of knowledge for future requests can be based on the acceptance or rejection of retrieved knowledge.

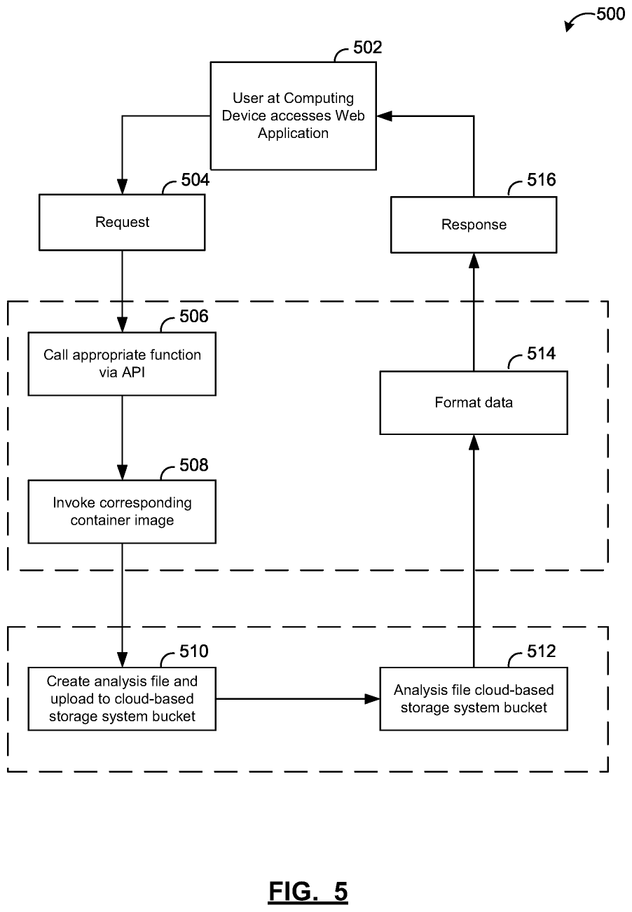

Reference is now made to FIG. 5, which illustrates a flowchart of an example method 500 for integrating knowledge from a plurality of data sources, in accordance with another example embodiment. Similar to example methods 300 and 330, example method 500 can be implemented by data management system 110 in a cloud computing environment including a container image and cloud-based storage.

Method 500 can begin at 502 with a user at a computing device, such as computing device 120 accessing the data management system 110 via a web application. The data management system 110 can associate the user at the computing device 120 with a user profile.

At 504, the user can submit a request via the web application. In at least one embodiment, the request can relate to a request to view documents relationships and analysis.

At 506, data management system 110 can call an appropriate function to process the request. In at least one embodiment, the function can be called via an application programming interface (API). At 508, data management system 110 can invoke a corresponding container image for the function. The function can result in an analysis dataset being created. In at least one embodiment, the analysis dataset can be a comma-separated value (CSV) file.

At 510, the analysis dataset can be uploaded to a cloud-based storage system in an appropriate bucket for the user.

At 512, the computing device 120, via the web application, can access the analysis dataset from the cloud-based storage system. That is, the computing device 120 can read or fetch the analysis data set from the user's bucket in the cloud-based storage.

At 514, the analysis dataset can be formatted for the web application at the computing device 120.

At 516, the analysis dataset can be transmitted to the computing device 120 for display to the user. That is, in response to the request at 504, the analysis dataset can be displayed at 516.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims.

We claim:

1. A system for integrating knowledge from a plurality of data sources, the system comprising:
a communication component to provide access to the plurality of data sources via a network; and
at least one processor in communication with the communication interface, the at least one processor being operable to:
store a unified split data structure specific to a user profile for derived knowledge, the unified split data structure being stored in a storage component within the network;
receive a request for knowledge from a computing device associated with the user profile;
in response to receiving the request, retrieve knowledge from the unified split data structure based on the request; and
display the retrieved knowledge at the computing device.

2. The system of claim 1, wherein the at least one processor is operable to, for each derived knowledge, store a knowledge label and data source location data in the unified split data structure, the knowledge label being indicative of the derived knowledge, the data source location data being indicative of a location of the data source accessible via the network.

3. The system of claim 2, wherein the at least one processor is operable to:
use the unified split data structure to:
select knowledge that corresponds to the request as the retrieved knowledge; and
obtain the data source location data of the retrieved knowledge; and
access the data source of the retrieved knowledge based on the data source location data.

4. The system of claim 2, wherein the at least one processor is further operable to, for each derived knowledge, store knowledge location data in the unified split data structure, the knowledge location data being indicative of a location of the knowledge within the data source.

5. The system of claim 2, wherein the at least one processor is operable to:
access the plurality of data sources; and
derive knowledge from the plurality of data sources.

6. The system of claim 5, wherein the at least one processor is operable to:
receive at least one data source from a computing device associated with the user profile; and
store the at least one data source in a storage component accessible via the network.

7. The system of claim 5, wherein the at least one processor is operable to:
identify one or more potential data sources accessible via the network;
prioritize the one or more potential data sources for processing;
access the potential data sources in order of priority; and
for each data source accessed, sequence the data source.

8. The system of claim 5, wherein the at least one processor is operable to:
for each data source:
generate a representation of the data source, the representation consisting of images, text, or a combination of images and text;
derive knowledge from the representation of the data source; and
generate at least one knowledge label indicative of knowledge derived from the representation of the data source.

9. The system of claim 8, wherein the at least one processor is operable to:
for each image of the representation of the data source,
divide the image into a plurality of image portions; and
expand each image portion of the plurality of image portions; and
derive knowledge from the expanded image portions of the plurality of image portions.

10. The system of claim 9, wherein the at least one processor is operable to use at least one of spatial optimization or grid optimization to divide the image into a plurality of image portions.

11. The system of claim 8, wherein the at least one processor is operable to:
derive at least one potential knowledge from the representation of the data source;
for each potential knowledge of the at least one potential knowledge,
generate a potential knowledge label indicative of the potential knowledge; and
determine whether to select the potential knowledge as the derived knowledge.

12. The system of claim 11, wherein the at least one processor is operable to:
display the at least one potential knowledge label at the computing device associated with the user profile; and
receive user input for the at least one potential knowledge label from the computing device associated with the user profile, the user input being used to determine whether to select the potential knowledge as the derived knowledge.

13. The system of claim 12, wherein:
the user input comprises one of a group consisting of approval of the potential knowledge, modification of the potential knowledge, and at least one additional potential knowledge; and
the at least one processor is operable to:
in response to receiving approval of the potential knowledge, select the potential knowledge as the derived knowledge;
in response to receiving a modification of the potential knowledge, use the modification of the potential knowledge as the derived knowledge; and
in response to receiving additional potential knowledge, use the potential knowledge and the at least one additional potential knowledge as the derived knowledge.

14. The system of claim 12, wherein the at least one processor is operable to derive the at least one potential knowledge based on user input previously received for existing derived knowledge.

15. The system of claim 11, wherein the at least one processor is operable to, for each potential knowledge of the at least one potential knowledge, generate an importance measure for the potential knowledge, the importance measure being used to determine whether to select the potential knowledge as the derived knowledge.

16. The system of claim 15, wherein the importance measure for the potential knowledge is based at least in part on the user profile and all terms used by any user profile.

17. The system of claim 15, wherein the at least one processor is operable to:
for each potential knowledge of the at least one potential knowledge:
determine whether the importance measure for the potential knowledge exceeds a pre-determined importance threshold value; and
if the importance measure exceeds the pre-determined importance threshold value, select the potential knowledge as the derived knowledge.

18. The system of claim 8, wherein the at least one processor is operable to use at least one of pattern-detection analysis, spatial algorithms, non-suppression analysis, or object-detection analysis to derive knowledge from the representation of the data source.

19. A computer-implemented method of integrating knowledge from a plurality of data sources, the method comprising operating at least one processor to:
store a unified split data structure specific to a user profile for derived knowledge;
receive a request for knowledge from a computing device associated with the user profile;
in response to receiving the request, retrieve knowledge from the unified split data structure based on the request; and
display the retrieved knowledge at the computing device.

20. The method of claim 19 comprises operating the at least one processor to, for each derived knowledge, store a knowledge label and data source location data in the unified split data structure, the knowledge label being indicative of the derived knowledge, the data source location data being indicative of a location of the data source accessible via the network.
